(19) United States
(12) Patent Application Publication
(10) Pub. No.: US 2015/0363734 A1
(43) Pub. Date: Dec. 17, 2015

(54) MULTIPLE OBJECTIVE OPTIMISATION METHOD AND DEVICE

(71) Applicant: MBDA France, Paris (FR)

(72) Inventors: Cèdric Leboucher, Le Plessis-Robinson (FR); Stéphane Le Menec, Le Plessis-Robinson (FR); Hyosang S. Shin, Le Plessis-Robinson (FR); Alexandre Kotenkoff, Le Plessis-Robinson (FR)

(73) Assignee: MBDA France, Le Plessis-Robinson (FR)

(21) Appl. No.: 14/766,442

(22) PCT Filed: Feb. 5, 2014
(86) PCT No.: PCT/FR2014/000030

§ 371 Date: Aug. 6, 2015

(30) Foreign Application Priority Data
Aug. 2, 2013 (FR) 13/00285

(51) Int. Cl. G06Q 10/06

(52) U.S. Cl. CPC G06Q 10/06316

(57) ABSTRACT

The invention relates to an optimization system (1) which comprises means (4) for entering data, means (2) for defining a criterion for each one of the objectives considered using the data entered, an element (6) for optimizing each one of the criteria individually in order to obtain an optimal person for each one of said criteria, an optimal person including at least one optimal value feasible for the criterion, an element (8) for determining, by means of an evolutionary game algorithm, the survival coefficients of said optimal persons, and an element (10) for determining an optimal solution by mutating the optimal persons, by means of the survival coefficients and of the application of a mutation operator, the optimal solution including at least one final optimal value enabling the achievement of all the objectives considered to be optimized.

### FIELD

The present disclosure relates to a device and to a multiple-objective optimisation method, as well as, in particular, a system and a resource allocation method comprising, respectively, such a method and such a device.

### BACKGROUND

“Multiple-objective optimisation” (or optimisation of a plurality of objectives) is understood to mean the definition of an optimal solution which best optimises a plurality of different objectives simultaneously.

Multiple-objective optimisation exists in numerous fields, in particular industrial fields in which such an optimised solution has to be defined. In general, these objectives are not always comparable in pairs, such as, for example, in the field of logistics when the aim is to maximise the number of deliveries whilst minimising the delivery time and the distance travelled by the delivery means. Mention may likewise be made, by way of illustration, of the configuration of a vehicle in which the performance must be maximised whilst minimising the weight and the fuel consumption thereof.

In order to achieve multiple-objective optimisation, a method is generally used which provides for implementation of the following steps:
A) defining a criterion for each of the objectives considered. Within the scope of the present disclosure, a criterion is a value or a set of calculable values which allow an objective to be achieved; then
B) achieving multi-criterion optimisation.

There is a real difficulty, or even an impossibility, in finding a solution which satisfies all the criteria in an optimal manner.

The principal defect and difficulty of the conventional methods relate to the comparison of criteria which, a priori, are not always comparable.

A first conventional approach, concerning an aggregation of the objectives, provides for the use of a linear or non-linear sum of the different functions. Such an approach has the special feature of converting a multiple-objective problem into a mono-objective problem, which is often simpler to solve.

However, such a modification of the problem in terms of modeling thereof necessitates compromises. A weighted sum involves the definition of the coefficients of this aggregation. The main difficulty of such a method is that the choice of these coefficients must be established in such a way as to exactly represent the problem defined. In addition, it may be noted that in most cases a simple modification of these coefficients can lead to completely different results. An analysis of sensitivity is therefore required in order to validate the robustness of the proposed solution.

In the case of the transformation of a multiple-objective problem into a mono-objective problem by the aggregation method, therefore, a difficulty is encountered in determining the coefficients which result from the linearisation of the objectives, but likewise concerning the validity of the modeling of this objective function and its pertinence, as the problem is to determine that one solution is better than another. This likewise leads to problems of sensitivity, which can render the solution unstable.

Another conventional approach, known as “Pareto,” provides for keeping all of the objectives and processing them independently according to a very simple principle: a solution is considered as optimal if no means exists for improving this solution according to an objective without impairing the others. One of the principal defects of this conventional method is that it requires the intervention of an expert in order to choose the solution most suitable for solving the problem.

In a Pareto approach, if the objectives are really very numerous, the comparison between them can become complicated. In the case where an expert must choose among a set of solutions, if this set becomes too large a real difficulty appears in the processing of this problem.

Consequently, for the multiple-objective optimisation considered in the present disclosure:
the large number of objectives to be optimised simultaneously renders the modeling by aggregation of the objectives very unstable and complicated. Moreover, the variety of scenarios to be processed renders evaluation of a solution in a generalist manner all the more complicated; and
although the Pareto approach appears be more suitable due to its more generalised approach to the objectives in seeking frontier points which meet all the objectives in an optimal manner, two major points are not tackled in this approach. The first relates to the form of the solution which is a set and which therefore requires the intervention of an expert for the final decision. The second is the independent processing of the criteria. In fact, the criteria often have a link between them, and to consider them without really taking account of the other criteria appears as a limitation of this approach.

Consequently, there is no device or technical means which makes it possible to achieve multiple-objective optimisation as mentioned above.

### SUMMARY

The present disclosure relates to a device for multiple-objective optimisation intended to remedy the aforementioned drawbacks.

To this end, according to the disclosure, the device for multiple-objective optimisation, of the type comprising:
first means for defining a criterion for each of the objectives considered; and
second means for automatically achieving multi-criterion optimisation,
   is noteworthy in that said second means comprise:
an element for optimising each of said criteria individually, in order to obtain an optimal individual for each one of these criteria, an optimal individual comprising at least one optimal and feasible value for said criterion;
an element for determining, using an evolutionary game algorithm, the survival coefficients of said optimal individuals; and
an element for determining an optimal solution by mutating the optimal individuals, using said survival coefficients and of the application of a mutation operator, said optimal solution comprising at least one final optimal value allowing the achievement of all of the objectives considered to be optimised.

Thus, a device is obtained which allows multiple-objective optimisation to be achieved.

Thus the device according to the present disclosure comprises, as specified below, technical means for generating data, technical means for automatically processing data (in order to determine an optimal solution) and technical means for using the results of the processing.

Furthermore, advantageously
the data inputting means comprise means (for example, a radar unit) which allows data to be supplied automatically and/or means allowing an operator to input data; and/or
the user means comprises display means which display the optimal solution on a screen; and/or
the display means and the means allowing an operator to input data from part of a human/machine interface; and/or
the device also comprises an element for verifying the feasibility of the optimal solution received from the third element, and, in the event of non-feasibility, for determining a new optimal solution corresponding to the feasible solution closest to this optimal solution.

Thus, for a given multiple-objective problem, each objective is considered individually and separately, by means of its associated criterion. Then, an optimal individual for each criterion considered is defined using conventional optimisation means. The solutions proposed must be feasible (that is to say achievable).

Next, a complete solution space which takes into account all the criteria, as well as the feasibility of the solution, is run through. The special feature of this phase resides in the principle that the feasibility of a solution becomes a binary criterion rendering the survival of an individual zero if the solution proposed is not feasible. Thus, the non-feasible individuals will disappear from the population (or the set) of solutions considered in order to leave space for only one population capable of living in the environment considered. This auto-elimination of non-feasible individuals is an advantage which makes it possible to move away naturally from solutions which are not achievable, and consequently the calculation time is significantly reduced.

Thus, by testing the survival of optimal individuals in their environment, how they will adapt to an environment where all the optimal individuals cohabit (according to each of the criteria) will be tested. Next, once the population is stabilised, a mutation operator modifies the individuals in order to create the individual (namely the optimal solution) capable of surviving in any environment in a stable manner.

The present disclosure therefore has the following advantages:
a capacity to process very heterogeneous objectives;
a natural selection of the most influential criteria in the presence of the other criteria; and
a possibility of comparing a large number of criteria.

Furthermore, the device according to the disclosure makes it possible to guarantee the stability of the final (optimal) solution. In fact, the principle of evolutionary games and of the convergence of results towards a stable solution makes it possible to guarantee stability of the results. This results in a robustness of the method according to the disclosure to minor changes in the choice of criteria.

The present disclosure therefore relates to a device for multiple-objective optimisation which makes it possible, in particular, to remedy the problems:
of an aggregation method, namely:
   significant modeling difficulties when the problem comprises many objectives; and
   a parameterisation which is very dependent on the application, and may be unstable; and
of a Pareto approach, namely:
   an independent consideration of the objectives without actually confronting them; and
   a request for intervention of an expert for the final decision.

The multiple-objective optimisation device according to the disclosure may be applied in many fields, such as in particular logistics (civil or military), transport management (railway networks, airports, air traffic), management of resources in the wide sense (field of computing, networks, fleet management), and the aeronautical field, both civil and military (mission planning, mission control).

The present disclosure likewise relates to a resource allocation system, which can be used in different fields, and which comprises the aforementioned device. It also relates to a system for handling threats in the military field, in particular of the command and control type (C2), comprising weapons assignment for handling the threats, said system comprising:
a first unit for retrieving information on the situation considered;
a second unit, comprising the aforementioned device, for processing this information in order to deduce therefrom an engagement proposition, by first of all determining firing windows on the basis of said information, then by deducing therefrom the engagement proposition from these firing windows; and
a third unit for implementing a step of approval of the engagement proposition, the engagement being carried out in accordance with an engagement proposition approved using said third unit.

Furthermore, advantageously:
the first unit comprises at least one radar unit which transmits information to said device on the air situation of the environment of a zone to be protected by the system; and/or
the system also comprises a human/machine interface allowing an operator to complete an approval; and/or
the system also comprises display means which display the engagement proposition approved by said third unit.

The disclosure also relates to a multiple-objective optimisation method. According to the disclosure, said multiple-objective optimisation method, according to which the following steps are implemented automatically:

A) data are generated and a criterion is defined for each of the objectives considered; and

B) multi-criterion optimisation is carried out which is then used,

is noteworthy in that in step B the following successive operations are implemented:

a) each of said criteria is optimised individually (and separately) in order to obtain an optimal individual for each of these criteria, an optimal individual comprising at least one optimal and feasible value for said criterion;

b) using an evolutionary game algorithm, the survival coefficients of said optimal individuals are determined; and

c) an optimal solution is determined by mutating the optimal individuals, using said survival coefficients and of the application of a mutation operator, said optimal solution comprising at least one final optimal value (or component) allowing the achievement of all of the objectives considered to be optimised.

Advantageously, in step B/b):

b1) for each of said optimal individuals, the performance thereof is evaluated according to each of the criteria other than the criterion relating to the optimal individual considered, so as to be able to obtain an evaluation matrix (or payoff matrix) which contains the corresponding scores of the different optimal individuals according to all the other criteria; and

b2) using said evaluation matrix and of the evolutionary game algorithm, the survival of the optimal individuals is evaluated according to each of the other criteria, in such a way as to obtain said survival coefficients. Preferably, said survival coefficients correspond to the equilibrium rates of the population of optimal individuals.

Furthermore, in an advantageous manner, in the step B/c), each component of the optimal solution is calculated using the barycentre of the corresponding components of the optimal individuals, weighted by the equilibrium rate.

In addition, in an embodiment, in the step B/c), a particle swarm optimisation is performed, as specified below.

Likewise, in an embodiment, a particle swarm optimisation is performed in step B/a), although other conventional solutions can likewise be implemented in this step B/a).

Moreover, advantageously, in step B/c), the feasibility of the optimal solution is verified, and, in the event of non-feasibility, a new optimal solution corresponding to the feasible solution closest to this optimal (non-feasible).solution is determined.

The present disclosure likewise relates to a resource allocation method, which can be used in different fields, as indicated above, and which comprises an optimisation method as mentioned above.

Furthermore, advantageously, it also relates to a method for handling threats in the military field, comprising weapons assignment for handling the threats. This method, according to which the following successive steps are implemented:

α) information on the situation considered is retrieved;

β) this information is processed in order to deduce therefrom a engagement proposition, by first of all determining firing windows on the basis of said information, then by deducing therefrom the engagement proposition from these firing windows, said engagement proposition specifying the weapons assignment and the firing instants for handling the threats; and

γ) a step of approval of the engagement proposition is provided, the engagement being carried out in accordance with a engagement proposition approved in this step γ),

is noteworthy according to the disclosure, in that in step B) the engagement proposition is determined by implementing the aforementioned multiple-objective optimisation method.

### BRIEF DESCRIPTION OF THE DRAWINGS

The figures of the appended drawings will provide a good understanding of how the invention can be carried out. In these drawings, identical references designate similar elements.

FIG. 1 is a block diagram of a device according to the disclosure.

FIG. 2 is a graph explaining the characteristics of the method implemented by the device according to the disclosure.

FIG. 3 is a block diagram of a system for handling threats, using a device according to the disclosure.

### DETAILED DESCRIPTION

Although applicable to numerous fields, the present disclosure applies more particularly to the military field and, more precisely, to the case of command and control (C2) systems that use a calculation for allocation of resources, namely an optimisation and coordination module that calculates numerically the best solution for allocation, for example, for N threats, with P missiles and L launchers (of missiles), with N, P and L being integers. Each of the proposed allocations results in new constraints on the others. The constraints in such a situation are multiple, ranging from operational constraints to technical constraints.

In this application, the objectives to consider are, for example, the balanced management of stores, the rapidity of intervention, the maximisation of the probabilities of success of the mission, the minimisation of the risks associated with a flight over a defended zone, the maximisation of the probabilities of survival of points which are defended, etc. In such a situation, the number of objectives varies generally between three and ten. These objectives comprise as many different criteria, which are generally not comparable directly in pairs. The requirement for an optimisation method capable of producing a compromise between all these heterogeneous aspects therefore becomes necessary for decision-making in real time, whilst taking account of the importance of each criterion.

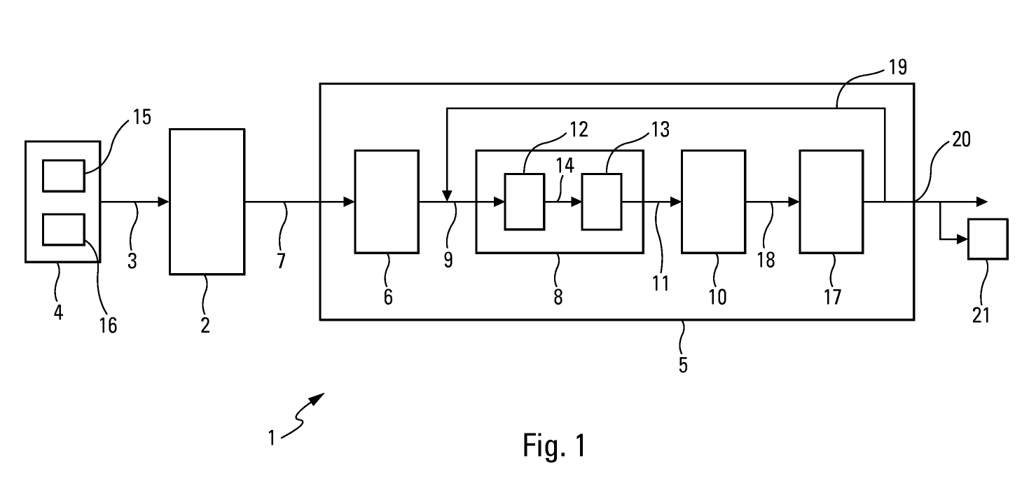

The device 1 according to the disclosure and shown schematically in FIG. 1 is intended to automatically produce multiple-objective optimisation, that is to say optimisation of a plurality of different objectives, in order to determine an optimal solution which best optimises the plurality of objectives thus considered.

In order to do this, said optimisation device 1 is of the type comprising:
data input means 4;
means 2 for defining a criterion for each of the objectives considered, from information or data received (by means of a connection 3) from the data input means 4;
means 5 for producing multi-criterion optimisation on the basis of these criteria; and
user means 21 specified below.

Within the scope of the present disclosure, the data input means 4 may comprise:
means 15 (devices or systems such as a radar unit for example) for automatically supplying data to the device 1; and/or
means 16 for allowing an operator to input data, in particular manually. Said means 16 can comprise a keyboard, a mouse, a touchpad, etc., or any other conventional means, associated with a screen, for example, that allow an operator to input data into said device 1.

According to the disclosure, said means 5 comprise, as shown in FIG. 1:
an element 6, which is connected by means of a connection 7 to the means 2 and which is formed in such a way as to optimise each of said criteria individually and separately in order to obtain an optimal individual for each one of these criteria. An optimal individual comprises at least one optimal and feasible value for said criterion;
an element 8, which is connected by means of a connection 9 to the element 6 and which is formed in such a way as to determine, using an evolutionary game algorithm, the survival coefficients of said optimal individuals received from the element 6; and
an element 10, which is connected by means of a connection 11 to the element 8 and which is formed in such a way as to determine an optimal solution by mutating the optimal individuals, using said survival coefficients and the application of a mutation operator. This optimal solution comprises at least one final optimal value allowing the achievement of all of the objectives considered to be optimised.

More precisely, the element 8 comprises:
means 12, which is connected by means of the connection 9 to the element 6 and which is formed in such a way as to evaluate, for each of said optimal individuals, the performance thereof according to each of the criteria other than the criterion relating to the optimal individual considered, so as to obtain an evaluation matrix (or payoff matrix) containing the scores of the optimal individuals according to all the other criteria; and
means 13, which is connected by means of a connection 14 to said means 12 and which is formed in such a way as to evaluate, using said evaluation matrix and of the evolutionary game algorithm, the survival of the optimal individuals according to each of the other criteria, in such a way as to obtain said survival coefficients. Preferably, said survival coefficients correspond to the equilibrium rates of the population of optimal individuals, as specified below.

Thus, for a given multiple-objective problem, the device 1 considers each objective individually and separately, by means of its associated criterion defined by the means 2. Then, the element 6 in a conventional manner defines the optimal individual for each particular criterion. The solutions proposed must be feasible (that is to say achievable) in order to generate solutions which make sense from the point of view of the system considered.

Next, a complete solution space which takes into account all the criteria, as well as the feasibility of the solution, is run through. The special feature of this phase resides in the principle that the feasibility of a solution becomes a binary criterion rendering the survival of an individual zero if the solution proposed is not feasible. Thus, the non-feasible individuals will disappear from the population (or the set) of solutions considered in order to leave space for only one population capable of living in the environment considered. This auto-elimination of non-feasible individuals is an advantage which makes it possible to move away naturally from solutions which are not achievable, and consequently, the calculation time is significantly reduced.

Thus, by testing the survival of optimal individuals in their environment, how they will adapt to an environment where all the optimal individuals cohabit (according to each of the criteria) will be tested. Next, once the population is stabilised, a mutation operator modifies the individuals in order to create the individual (namely the optimal solution) capable of surviving in any environment in a stable manner.

The element 10 calculates each component of the optimal solution, for example, using the barycentre of the corresponding components of the optimal individuals, weighted by the equilibrium rate.

Moreover, the device 1 also comprises an element 17 for verifying the feasibility of the optimal solution received from the element 10 by means of a connection 18, and, in the event of non-feasibility, for determining a new optimal solution corresponding to the feasible solution closest to this optimal (non-feasible) solution. In order to do this, the output of the element 17 can be connected to the connection 9 via a connection 19 in order that the means 8 and 10 can repeat their processing. The element 17 then transmits the optimal solution by means of a connection 20 to the user means 21, for example display means (which displays the optimal solution on a screen) or printing means (which prints the optimal solution). These means 21 can form with the means 16 a human/machine interface.

A description in greater detail is given below of the processing carried out by the different elements of the means 5.

Thus, the element 6 of the means 5 optimises individually each of the criteria C1 to CN considered, N being an integer, using at least one appropriate optimisation algorithm. In order to do this, the element 6 can use different types of algorithm. In an embodiment, it uses an algorithm of the particle swarm optimisation type, as defined for example in an article by Leboucher, Chelouah, Siarry and Le Ménec, entitled “A Swarm Intelligence Method Combined to Evolutionary Game Theory Applied to the Resources Allocation Problem” and published in the “International Journal of Swarm Intelligence Research” (IJSIR), vol. 3, p. 20-38, 2012.

The solution provided should be unique and optimal according to each criterion.

Then, after the reception of the population of the optimal individuals I1 to IN according to each of the criteria considered, determined by the element 6, the means 12 evaluates the performance of the optimal individual I1 (according to the criterion C1) with C2, C3, . . . , CN. Thus, the means 12 obtains the performance of this individual I1 in the other solution spaces. The evaluation is performed by the means 12 for all the individuals I1 to IN. All the spaces are standardised in order that the comparison makes sense.

Then, a payoff matrix (or evaluation matrix) A is obtained, of which a value A(i,j) evaluates the optimal individual Ii (according to Ci) in Cj.

In an example, for N=6 (for the individuals I1 to I6), a payoff matrix of the 6×6 type is obtained comprising the scores of the optimal solutions according to the other criteria. By way of illustration, this matrix A may be expressed as:

A =

| | | | | | |
|---|---|---|---|---|---|
| 1.0000 | 0.0196 | 0.3309 | 0.4243 | 0.2703 | 0.1971 |
| 0.8217 | 1.0000 | 0.4299 | 0.8878 | 0.3912 | 0.7691 |
| 0.3968 | 0.8085 | 1.0000 | 0.7551 | 0.3774 | 0.2160 |
| 0.7904 | 0.9493 | 0.3276 | 1.0000 | 0.6713 | 0.4386 |
| 0.8335 | 0.7689 | 0.1673 | 0.8620 | 1.0000 | 0.9899 |
| 0.5144 | 0.8843 | 0.5880 | 0.1548 | 0.1999 | 1.0000 |

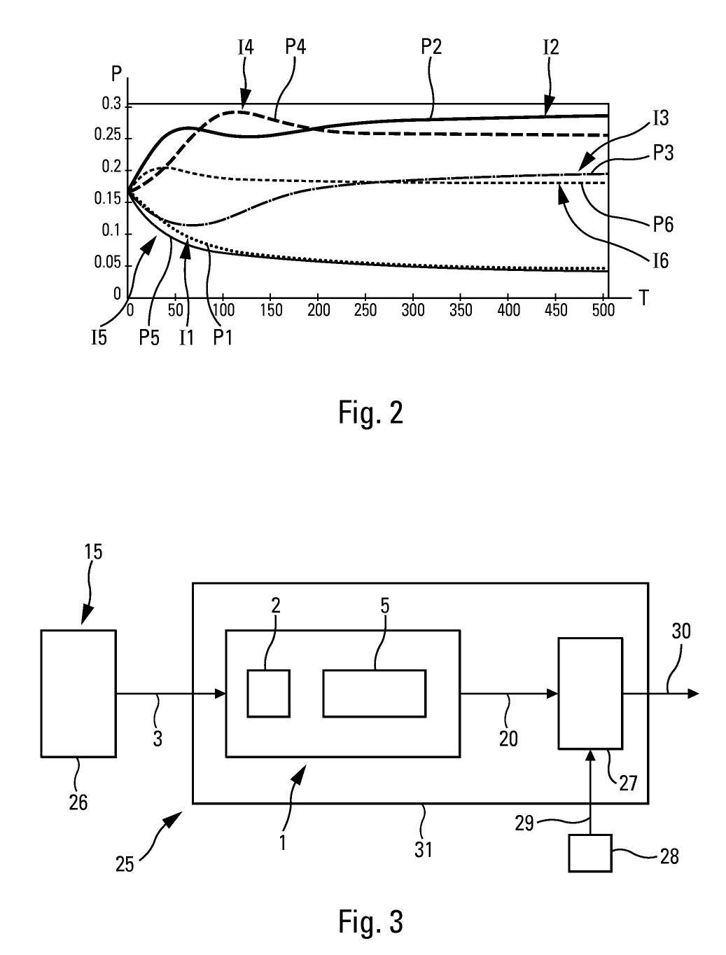

Once the payoff matrix or evaluation matrix A is established, the means 13 uses an evolutionary game algorithm in order to verify the survival of the optimal individuals engaged according to the other criteria. A stable state of the population is then obtained where the final proportion of individuals indicates the rate of resistance of an optimal individual Ii (of criterion Ci) to the other criteria Cj, as shown in FIG. 2, which illustrates for each of the individuals I1 to I6 the proportion P of the population (respectively P1 to P6) as a function of the time T.

In this example of FIG. 2, it can be seen that the individuals I1 and I5 are not suitable for all the criteria. On the other hand, the individuals I2 and I4 adapt very well to the other criteria. The individuals I3 and I6 meanwhile exhibit an adaptation between those of the individuals I1 and I5 and those of the individuals I2 and I4. On the basis of these results it is considered that the optimal individual for all of these criteria is composed of the equilibrium rates of the ESS (evolutionary stable strategy) population.

The element 10 then applies a mutation operator to these individuals after having identified the differences between the individuals in order to preserve the “good genes” of each individual. A mutant individual (namely said optimal solution) is then obtained that is capable of surviving in a balanced manner in the solution space of the criteria considered.

This process of mutating the existing solutions can take the form of a barycentre for each component of the solution, weighted by the equilibrium rate (ESS) obtained.

The mutation process implemented by the element 10 can likewise take different forms. For example, an optimisation of the particle swarm optimisation type is likewise possible. The optimal solutions according to each criterion then represent the information particles of each one. Thus, at each iteration of the algorithm, the payoff matrix is recomposed in order to take account of the current solution and its survival in the environment of the optimal individuals. This procedure continues until the entire swarm has been stabilised. The final solution is an average of the positions obtained by the swarm (adjustable precision for the stop criterion; for example as soon as all the particles are situated at least one thousandth of a second from one another, the swarm is considered to be stabilised).

This process of evolution in order to converge towards a stable and feasible solution may be obtained on the basis of numerous different processes (genetic algorithms or the like).

Thus the device 1 according to the disclosure, as described above, has the following advantages:
a capacity to process very heterogeneous objectives;
a natural selection of the most influential criteria in the presence of the other criteria; and
a possibility of comparing a large number of criteria.

Furthermore, said device 1 makes it possible to guarantee the stability of the final solution. In fact, the principle of evolutionary games and of convergence of the results towards a stable solution makes it possible to guarantee stability of the results. This results in a robustness of the device 1 according to the disclosure to minor changes in the choice of criteria.

Moreover, the device 1 makes it possible to evaluate an individual in the other solution spaces (the spaces defined by the other criteria). Thus, this comparison makes it possible to evaluate the value of a solution according to all the criteria and therefore to compare them directly. This makes it possible likewise to detect the criteria which are the most predominant among all the criteria.

The device 1 according to the present disclosure may be applied to numerous fields.

In a preferred application, said device 1 forms part of a system 25 for handling threats in the military field, in particular of the command and control type, comprising weapons assignment, in particular missiles, for handling threats, in particular airborne ones.

This system 25 comprises, as shown in FIG. 3:
means 15, which comprises at least one radar unit 26 which transmits information on the surrounding situation, in particular in the air, to the device 1 via the connection 3. The means 15 may already form part (at least in part) of the device 1 or may be dedicated to the system 25. The radar unit 26 detects the threats and transmits the corresponding information, in particular relating to the position and kinematics of threats;
said device 1, which processes this information (which is first formatted by the means 2) in order to deduce therefrom an engagement proposition, by first of all determining using the element 6 firing windows on the basis of said formatted information, then by deducing therefrom the engagement proposition from these firing windows. This engagement proposition specifies a weapons assignment and presents firing instants (or times) in order to handle (in particular to destroy) the different threats; and
means 27 for implementing a step of approval of the engagement proposition, received from the device 1 by the connection 20. The approval is given by an operator using means 28 (for example forming part of the aforementioned human/machine interface), which is connected by means of a connection 29 to said means 27. To this end, the engagement proposition may for example be displayed by the means 21.

Then, the engagement is carried out in accordance with the engagement proposition approved by said means 27 and transmitted by a connection 30, for example to display means (not shown). The means 27 and the device 1 (in particular the means 2, 6, 8, 10 and 17 thereof) for example form part of an information processing unit 31.

In the case of a command and control system 25 in the military field, if the two criteria which allow evaluation of a good solution are, on the one hand, the reactivity of the system to intervene quickly, and on the other hand the maximisation of the probability of success of the mission, there are two independent and even antagonistic criteria. In fact, it is better to wait until a target is close in order to increase the chances of success of the firing. However, waiting until the target moves closer impairs the quality of the solution according to the system reactivity criterion. Optimisation according to each criterion supplies the optimal solution according to each of the criteria, then the evolutionary games theory proceeds to the final optimisation step which makes it possible to determine the extent to which the solutions obtained can survive in the presence of one another. For this, first of all, the solution which optimises the reactivity criterion in the solutions space of the probability of success criterion is evaluated. The score obtained in the other space is used in the payoff matrix. The same procedure is followed for the solution which maximises the probability of firing success in terms of reactivity.

By way of illustration, a particular example is set out below relating to such an application to a system 25 of type C2.

In this example, a system 25 of type C2 is considered that defends a zone attacked by three threats (or targets Tj to be destroyed, j being an integer from 1 to 3). This system has three missiles Mi, i being an integer from 1 to 3, in order to defend this zone.

It is assumed that M1 is allocated to T1, M2 to T2 and M3 to T3. The firing sequence which optimises, at the same time, the capacity of the system to intervene as soon as possible and its capacity to maximise the probability of success of the mission (destruction of the targets Tj) has to be determined. It is therefore necessary to find a compromise between these two objectives, which are antagonistic. The device 1 makes it possible to automate this procedure in a reliable manner.

By way of illustration, it is assumed that the optimal solution in terms of reactivity (or optimal individual) is S1=[15 18 21], and that the solution which maximises the overall probability of success (or optimal individual) is S2=[31 24 45]. The three components of each of these solutions represent the firing instants (defined in units of time) respectively of the three missiles M1 to M3. Thus, for the criterion S1, the optimal firing instant for the missile M2 is 18. It is assumed that the payoff matrix A0 is

$$A 0 = \begin{matrix}[ \begin{matrix}0 & 0.2\end{matrix} ] \\ [ \begin{matrix}0.7 & 0\end{matrix} ]\end{matrix}$$

The equilibrium rate obtained is ESS=[0.22 0.78]. Thus, the solution of the strategy S2 survives with a higher rate (survival coefficient of 0.78) than the solution of reactivity S1 (survival coefficient of 0.22). Taking into account the barycentric mutation indicated above, the element 10 then determines the following optimal solution S:

S=[15*0.22+31*0.78 18*0.22+24*0.78 21*0.22+45*0.78]

S=[27.48 22.68 39.72].

Thus, an optimal solution S is obtained that takes account of all the objectives and optimises all the criteria.

A supplementary operation remains necessary in order to validate the feasibility of the optimal solution obtained. In order to do this, the element 17 applies a simple correction procedure a posteriori which is, for example, based on the Euclidian distance with respect to the closest feasible solution. Thus, if a firing instant (or time) obtained is not possible because of system constraints, for example, it is sufficient simply to postpone the proposed firing instant to the available instant closest to the instant which is not feasible.

The device 1 has been described above in an application to a system 25 of the type C2. Nevertheless, numerous other applications are possible. Thus, most problems of optimisation associated with the industry are in the form of multiple-objective problems with objectives which are very often antagonistic.

This type of situation likewise appears in optimal control applications where, for example, a mechanical arm (or element) should start from a first point in order to go towards a second point as quickly as possible, but where it is essential to meet a condition of not going beyond the second point. In surgery, for example, an unstable system cannot be tolerated and the movements of the mechanical arm must be very precise, but also sufficiently quick in order to render the operation feasible. The device 1 according to the disclosure makes it possible to determine a solution which makes it possible to implement these two objectives in an optimal manner.

Furthermore, mention may also be made of:
the field of finance where antagonistic objectives may have to be optimised;
the field of logistics, where there is a need for example to minimise the delivery time whilst minimising the costs for the business; and
the military field with reconnaissance of terrain by drones. The drones must fly at a sufficient altitude to have an overview of the zone to be observed, but must remain unobtrusive in order not to compromise their survival. Consequently, it is necessary to reach a compromise between the quality of observation and the chance of survival.

While illustrative embodiments have been illustrated and described, it will be appreciated that other embodiments are also possible within the scope of the present disclosure.

1. A multiple-objective optimisation device, said device comprising:
data input means;
first means for defining a criterion for each of the objectives considered on the basis of inputed data;
second means for automatically achieving multi-criterion optimisation; and
user means,
wherein said second means comprises at least:
a first element for optimising each of said criteria individually, in order to obtain an optimal individual for each one of these criteria, an optimal individual comprising at least one optimal and feasible value for said criterion;
a second element for determining, using an evolutionary game algorithm, survival coefficients of said optimal individuals; and
a third element for determining an optimal solution by mutating the optimal individuals, using said survival coefficients and of the application of a mutation operator, said optimal solution comprising at least one final optimal value allowing the achievement of all of the objectives considered to be optimised.

2. The device according to claim 1, wherein the data inputting means allow data to be supplied automatically.

3. The device according to claim 1, wherein the data inputting means allow an operator to input data.

4. The device according to claim 1, wherein the user means comprises display means configured to display the optimal solution on a screen.

5. The device according to claim 1, wherein data inputting means and the user means form part of a human/machine interface.

6. The device according to claim 1, wherein the device also comprises an element for verifying the feasibility of the optimal solution received from the third element, and, in the event of non-feasibility, for determining a new optimal solution corresponding to the feasible solution closest to this optimal solution.

7. The device according to claim 1, wherein the second element comprises:
means for evaluating, for each of said optimal individuals, the performance thereof according to each of the criteria other than the criterion relating to the optimal individual considered, so as to be able to obtain an evaluation matrix containing the scores of the optimal individuals according to all the other criteria; and
means for evaluating, using said evaluation matrix and of the evolutionary game algorithm, the survival of the optimal individuals according to each of the other criteria, in such a way as to obtain said survival coefficients.

8. A resource allocation system comprising the device specified in claim 1.

9. A system for weapons assignment for handling threats in the military field, said system comprising:
a first unit for retrieving information on the situation considered;
a second unit for processing said information in order to deduce therefrom an engagement proposition, by first of all determining firing windows on the basis of said information, then by deducing therefrom the engagement proposition from the firing windows, said engagement proposition specifying the weapons assignment and firing instants for handling the threats; and
a third unit for implementing a step of approval of the engagement proposition, the engagement being carried out in accordance with an engagement proposition approved using said third unit,
characterised in that said second unit comprises the device specified in claim 1.

10. The system according to claim 9, wherein the first unit comprises at least one radar unit which transmits information on a surrounding situation to said device.

11. The system according to claim 9, further comprising a human/machine interface allowing an operator to complete an approval.

12. The system according to claim 9, further comprising display means configured to display the engagement proposition approved by said third unit.

13. A multiple-objective optimisation method, according to which the following steps are implemented automatically:
A) generating data and defining a criterion for each of the objectives considered; and
B) achieving multi-criterion optimisation wherein in step B), the following successive operations are implemented:
a) optimising each of said criteria individually in order to obtain an optimal individual for each one of said criteria, an optimal individual comprising at least one optimal and feasible value for said criterion;
b) using an evolutionary game algorithm to determine survival coefficients of said optimal individuals; and
c) determining an optimal solution by mutating the optimal individuals, using said survival coefficients and application of a mutation operator, said optimal solution comprising at least one final optimal value allowing the achievement of all of the objectives considered to be optimised.

14. The method according to claim 13, wherein in step b):
b1) for each of said optimal individuals, evaluating the performance thereof in the form of a score according to each of the criteria other than the criterion relating to the optimal individual considered, so as to be able to obtain an evaluation matrix which contains the corresponding scores of the different optimal individuals according to all the other criteria; and
b2) using said evaluation matrix and the evolutionary game algorithm, evaluating the survival of the optimal individuals according to each of the other criteria, in such a way as to obtain said survival coefficients.

15. A method for handling threats in the military field, comprising weapons assignment for handling the threats, according to which method the following successive steps are implemented:
α) retrieving information on the situation considered;
β) processing the information in order to deduce therefrom an engagement proposition, by determining firing windows on the basis of said information, then by deducing therefrom the engagement proposition from these firing windows, said engagement proposition specifying the weapons assignment and firing instants for handling the threats; and
γ) approving the engagement proposition, the engagement being carried out in accordance with the engagement proposition,
characterised in that in step b the engagement proposition is determined by implementing the method specified in claim 13.
